(19) United States
(12) Patent Application Publication
(10) Pub. No.: US 2023/0208184 A1
(43) Pub. Date: Jun. 29, 2023

(54) CONTROL UNITS, SYSTEMS, AND METHODS FOR BACK-UP POWER MANAGEMENT DURING A SUPPLY POWER OUTAGE

(71) Applicant: Rivian IP Holdings, LLC, Plymouth, MI (US)

(72) Inventors: Khaled Bahei-Eldin, Irvine, CA (US); Deidre Yiu, San Francisco, CA (US)

(21) Appl. No.: 17/564,785

(22) Filed: Dec. 29, 2021

(51) Int. Cl. H02J 9/06; H02J 1/10; B60L 53/53; B60L 53/68

(52) U.S. Cl. CPC H02J 9/061; H02J 9/068; H02J 1/102; H02J 9/062; B60L 53/53; B60L 53/68

(57) ABSTRACT

Various disclosed embodiments include illustrative controller units, systems, vehicles, and methods. In an illustrative embodiment, an energy management control unit includes a communication device, a processor, and non-transitory computer-readable media having computer-executable instructions. The instructions cause the processor to receive a grid energy supply value and determine a grid energy supply outage responsive to the received grid energy supply value. Responsive to the determined grid energy supply outage, the instructions cause the processor to receive plug-in status of a removable direct current (DC) energy storage device, receive first available power information of the removable DC energy storage device responsive to the plug-in status indicating available, receive active load power usage information responsive to the first available power information being greater than a minimum reserve threshold, and shed a first electrical load responsive to the determined active load power usage information being greater than a first shedding threshold.

### INTRODUCTION

The present disclosure relates to managing reserve power usage during a grid power supply outage. If a building is unoccupied during a grid power supply outage, then manual management of devices drawing power from a back-up system may not occur and available back-up power may not be used efficiently. The statements in this section merely provide background information related to the present disclosure and may not constitute prior art.

### BRIEF SUMMARY

Various disclosed embodiments include illustrative controller units, systems, vehicles, and methods.

In an illustrative embodiment, an energy management control unit includes a communication device, a processor configured to receive and send information to components of a structure via the communication device, and non-transitory computer-readable media configured to store computer-executable instructions. The instructions are configured to cause the processor to determine first available power information of the removable DC energy storage device, receive active load power usage information responsive to the first available power information being greater than a minimum reserve threshold, and shed a first electrical load responsive to the determined active load power usage information being greater than a first shedding threshold associated with the first available power information.

In another illustrative embodiment, a system includes circuit breaker devices coupled between electrical loads and a grid energy supply, a removable DC energy storage device charger, a fixed DC energy storage device, a bidirectional inverter couplable to the circuit breaker devices, the removable DC energy storage device charger, and the fixed DC energy storage device, and an energy management control unit (EMCU). The EMCU includes a communication device, a first processor configured to receive and send information to the circuit breaker devices, the bidirectional inverter, and the removable DC energy storage device charger via the communication device, and first non-transitory computer-readable media configured to store first computer-executable instructions. The instructions are configured to cause the first processor to determine a grid energy supply outage responsive to the sensed grid energy supply value. Responsive to the determined grid energy supply outage, the instructions are configured to cause the processor to determine first available power information of the removable DC energy storage device, receive active load power usage information responsive to the first available power information being greater than a minimum reserve threshold, and send a first off instruction to a first one of the circuit breaker devices responsive to the determined active load power usage information being greater than a first shedding threshold associated with the first available power information.

In another illustrative embodiment, a method includes determining first available power information of the removable DC energy storage device, receiving active load power usage information responsive to the first available power information being greater than a minimum reserve threshold, and shedding a first electrical load responsive to the determined active load power usage information being greater than a first shedding threshold associated with the first available power information.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1 is an illustration in partial schematic form of an illustrative load management system in a structure.

FIG. 2 is an illustration in partial schematic form of the system of FIG. 1.

FIG. 3 is a block diagram of a control unit component included in the system of FIG. 1.

FIG. 4 is a block diagram of a mobile device component included in the system of FIG. 1.

FIG. 5 is a block diagram of a circuit breaker component included in the system of FIG. 1.

FIGS. 6A-B is an illustration of a user interface in a first scenario presented by the mobile device component of the system of FIG. 1.

FIGS. 7A-C is an illustration of a user interface in a second scenario presented by the mobile device component of the system of FIG. 1.

FIG. 8 is a flow diagram of an illustrative method performed by the system of FIG. 1.

Like reference symbols in the various drawings generally indicate like elements.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Various disclosed embodiments include illustrative control units, systems, and methods. As will be explained below, such embodiments can control back-up power management during supply power outage events.

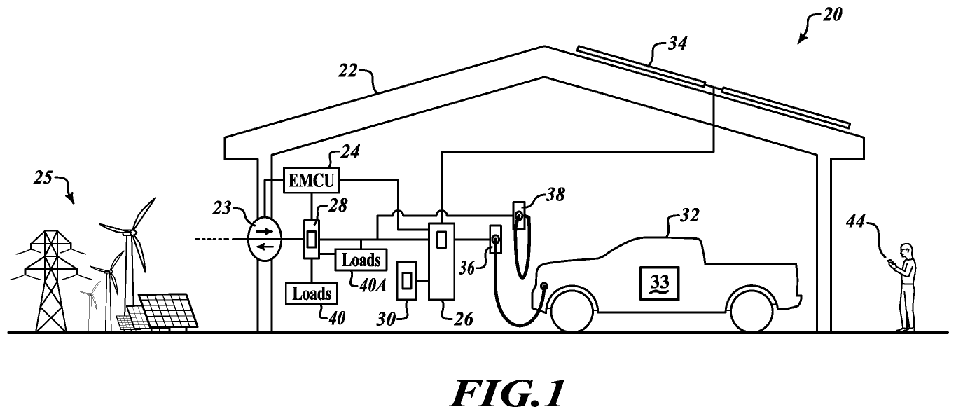

Given by way of non-limiting overview and referring to FIGS. 1-3, in various embodiments a system 20 includes circuit breaker devices 28 coupled between heavy electrical loads 40 and a grid energy supply 25, a grid energy supply sensor 23 configured to sense a grid energy supply value, a removable direct current (DC) energy storage device charger 36, a fixed DC energy storage device(s) 30, a bidirectional inverter 26 couplable to the circuit breaker devices 28 and directly couplable to designated essential/critical loads 40A, the removable DC energy storage device charger 36, and the fixed DC energy storage device(s) 30, and an energy management control unit (EMCU) 24. The EMCU 24 includes a communication device 64, a first processor 60 configured to receive and send information to the circuit breaker devices 28, the bidirectional inverter 26, and the removable DC energy storage device charger 36 via the communication device 64, and first non-transitory computer-readable media (memory 62) configured to store first computer-executable instructions. The instructions are configured to cause the first processor 60 to determine a grid energy supply outage responsive to the sensed grid energy supply value. Responsive to the determined grid energy supply outage, the instructions are configured to cause the processor 60 to receive plug-in status of a removable DC energy storage device 33 included in a mobile or removable device 32 from the removable DC energy storage device charger 36 via the communication device 64, receive first available power information of the removable DC energy storage device 33 responsive to the plug-in status indicating available, receive active load power usage information responsive to the first available power information being greater than a minimum reserve threshold, and send a first off instruction to a first one of the circuit breaker devices 28 responsive to the determined active load power usage information being greater than a first shedding threshold associated with the first information.

Now that an overview has been presented by way of illustration only and not of limitation, details will be set forth by way of non-limiting examples given by way of illustration only and not of limitation.

As shown in FIG. 1, in various embodiments the illustrative system 20 is configured to control back-up power delivery to the electrical loads 40 of a structure 22. In various embodiments the structure 22 may be a house or any other structure capable of connecting to an alternating current (AC) grid energy supply 25 or other external energy supply/source. The system 20 includes the energy management control unit (EMCU) 24, the grid energy supply sensor 23, the circuit breaker devices 28, the bidirectional inverter 26, the removable DC energy storage device charger 36, the electrical loads 40, and the fixed energy storage device(s) 30.

In various embodiments the system 20 also includes a mobile, user interface device (personal electronics device (PED)) 44 configured to communicate with the EMCU 24. The PED 44 allows a user to control when the electrical loads 40 are deactivated during an energy source outage. The PED 44 will be described in more detail below.

In various embodiments the grid AC energy supply sensor 23 is configured to sense an energy supply value from the AC grid energy supply 25. Those skilled in the art will appreciate that the AC grid energy supply 25 may provide electrical power from a variety of different devices, such as wind turbine, solar cell, geothermal, nuclear power plants, hydro-electric power plants, natural gas power plants, coal-run power plants, or any mechanism that can produce AC electrical power. The supply of energy from the AC grid energy supply 25 may be affected by weather or other disruption events, thus causing an outage of power at the structure 22. The output of the grid AC energy supply sensor 25 provides sensed values of a possible power outage. The sensed values are sent to the EMCU 24 for analysis. Current sensors or other power supply sensors are extremely well known in the art and no further explanation is necessary for a person of ordinary skill in the art to understand disclosed subject matter.

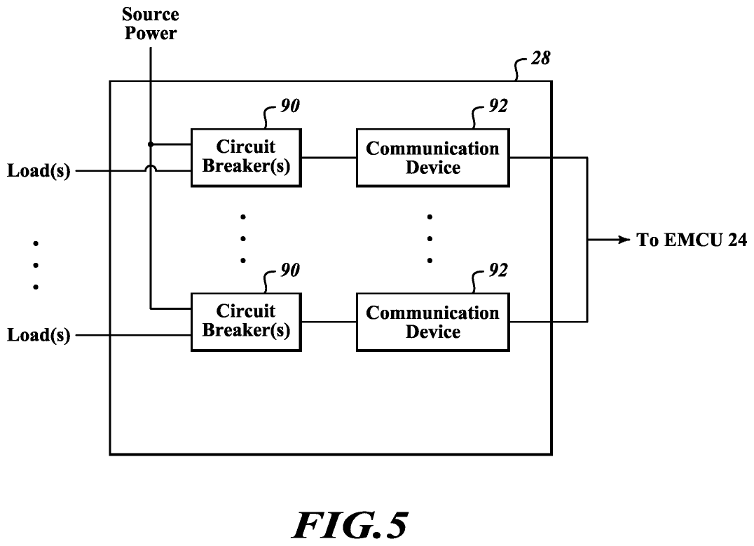

The circuit breaker devices 28 are electrically coupled between the electrical loads 40 and the grid energy sensor 23. The circuit breaker devices 28 are described in more detail below in FIG. 5. The electrical loads 40 may include electric appliances, heating and air conditioning equipment, water heating and supply systems, lights, fans, or the like. The system 20 may optionally include a removable AC-DC energy storage device charger 38 to provide an AC charge to a vehicle having rechargeable batteries with an onboard inverter. The removable AC-DC energy storage device charger 38 may include a class to AC charger or comparable charging device. The removable AC-DC energy storage device charger 38 acts is an electrical load when actively charging.

In various embodiments the removable DC energy storage device charger 36 is configured to connect to the removable DC energy storage device 33 of the mobile or removable device 32. It will be appreciated that the mobile or removable device 32 or a vehicle attachable to the removable AC-DC energy storage device charger 38 can be any type of vehicle or device whatsoever as desired without limitation. The chargers 37 and 38 are couplable to energy storage devices (batteries) 33 that are removable because the energy storage devices 33 are located in the removable device 32—devices intended for frequent removal from the structure 22. Given by way of non-limiting example, in various embodiments the mobile or removable device 32 may be an electric vehicle (that is, an all-electrically driven vehicle) or a hybrid vehicle. For example and given by way of non-limiting examples, in various embodiments the vehicle may include a motor vehicle driven by wheels and/or tracks, such as, without limitation, an automobile, a truck, a sport utility vehicle (SUV), a van, an all-terrain vehicle (ATV), a motorcycle, an electric bicycle, a tractor, a lawn mower such as without limitation a riding lawn mower, a snowmobile, and the like. Given by way of further non-limiting examples, in various embodiments the mobile or removable device 32 may include a marine vessel such as, without limitation, a boat, a ship, a submarine, a submersible, an autonomous underwater vehicle (AUV), and the like. Given by way of further non-limiting examples, in various embodiments the mobile or removable device 32 may include an aircraft such as, without limitation, a fixed wing aircraft, a rotary wing aircraft, and a lighter-than-air (LTA) craft.

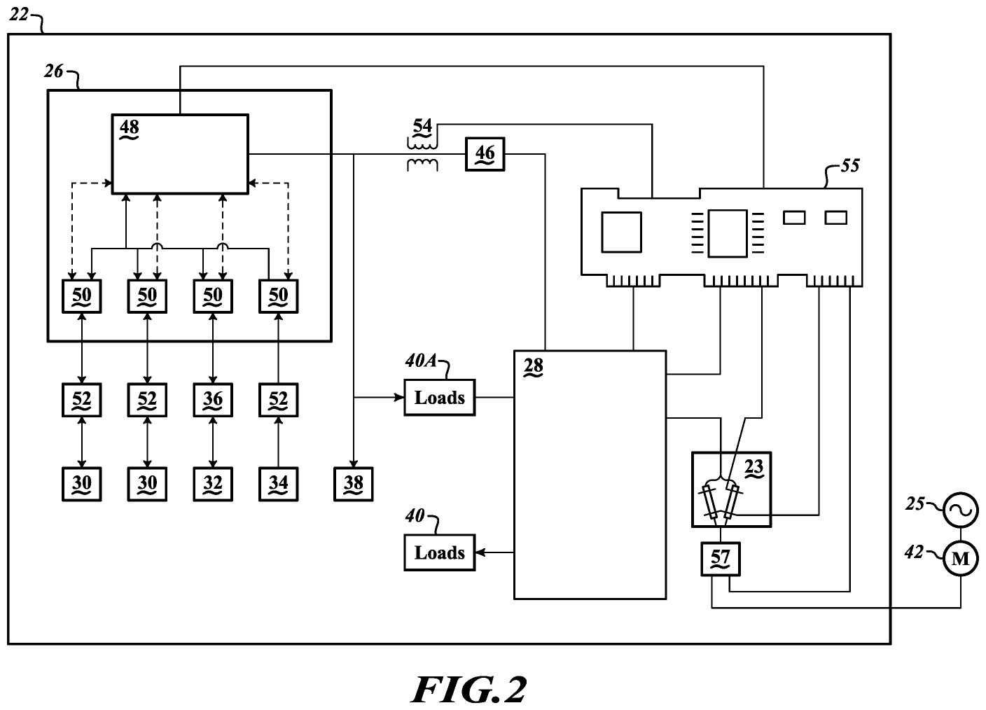

In various embodiments the bidirectional inverter 26 is electrically couplable to the circuit breaker devices 28, the removable DC energy storage device charger 36, the fixed DC energy storage device(s) 30 and additional DC energy sources or storage devices. Additional DC energy sources may include an alternative energy source, such as, without limitation, a wind turbine, solar panels 34, generator, or the like. The bidirectional inverter 26 will be described in more detail below in FIG. 2.

In various embodiments and given by way of example only and not of limitation, the fixed DC energy storage device(s) 30 and the removable DC energy storage device(s) 33 in the mobile or removable device 32 suitably include high energy rechargeable batteries that store electrical charge, discharge electrical current upon request, and recharge. The rechargeable batteries may be structured in any desirable form, such as without limitation cylindrical, pouch, prismatic, massless, or other comparable forms. In various embodiments the rechargeable batteries may include Iron-air batteries, Li-ion batteries, such as without limitation Nickel Cobalt Aluminium, Lithium Manganese Cobalt, or Lithium Manganese Oxide batteries. However, other materials may be used that provide comparable recharging, energy density, and energy discharge capabilities.

Referring additionally to FIG. 2, in various embodiments the system 20 may also include an electrical meter 42 and an islanding contactor 57 located between the AC grid energy supply 25 and the grid energy supply sensor 23 and a current sensor 54 and an AC disconnect device 46 disposed between the circuit breakers 28 and the bidirectional inverter 26. The EMCU 24 is included in a housing 55 that includes multiple ports for receiving a supply power line from one of the circuit breakers 28, for receiving information from the bidirectional inverter 26, the grid energy supply sensor 23, and the current sensor 54, and for sending off and/or on instructions to particular ones of the circuit breakers 28.

In various embodiments the bidirectional inverter 26 includes an AC-DC bidirectional inverter device 48 and multiple DC-DC converters 50 that are configured according to the device they are connected to. The AC-DC bidirectional inverter device 48 converts AC received from the circuit breaker devices 28 to DC and converts DC received from the fixed DC energy storage device(s) 30 and the mobile or removable device 32 back to AC. First and second DC-DC converters 50 connect to different fixed DC energy storage device(s) 30 via respective DC disconnect devices 52. A third DC-DC converter 50 connects to the removable DC energy storage device charger 36. A fourth DC-DC converter 50 connects to the solar panels 34. Bidirectional inverters, DC-DC converters, DC disconnect devices, and AC disconnect devices are extremely well known in the art and no further explanation is necessary for a person of skill in the art to understand disclosed subject matter.

In various embodiments, the bidirectional inverter 26 receives first available power information from the mobile or removable device 32. Also, the bidirectional inverter 26 receives second available power information from the fixed DC energy storage device(s) 30. The bidirectional inverter 26 sends the first and second available power information to the EMCU 24 for analysis. The available power information indicates the amount of power available for powering the heavy electrical loads 40 and/or the essential/critical loads 40A. The amount of power available for powering the loads 40 and 40A may be the amount of power currently stored in the storage devices 30 and 33.

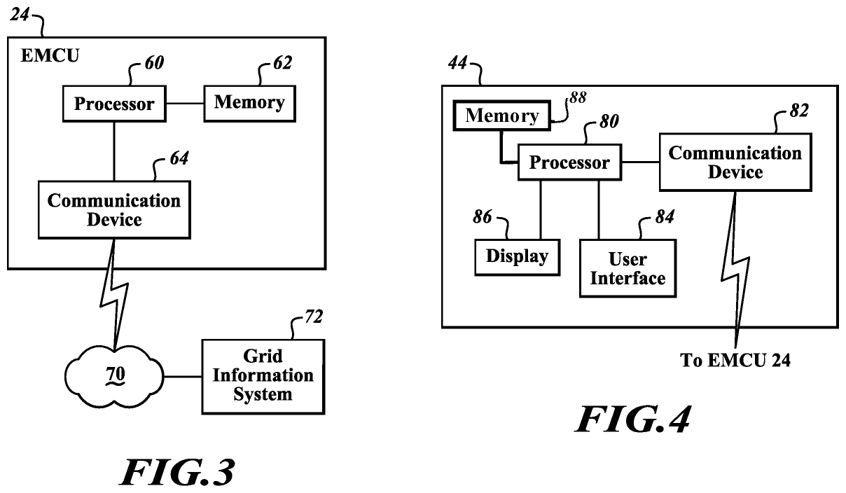

Referring additionally to FIG. 3, in various embodiments the EMCU 24 includes a communication device 64, a first processor 60, and first non-transitory computer-readable media (memory 62) configured to store first computer-executable instructions. The first processor 60 is configured to receive and send information to the circuit breaker devices 28, the bidirectional inverter 26, and the removable DC energy storage device charger 36 via the communication device 28. The first processor 60 may also communicate with a grid information system 72 via a data network 70. The data network 70 may be a public or private data network, such as without limitation a cellular network, a local area network (LAN), a wide area network (WAN), or the like. The grid information system 72 may provide information of the grid energy supply 25, such outage information, a forecast of grid power reinstatement, or other information. Operation of the EMCU 24 is described in more detail below.

Referring additionally to FIG. 4, in various embodiments the PED 44 includes a communication device 82, a user interface 84 configured to present information and receive input from a user, a second processor 80, and second non-transitory computer-readable media (memory 88). The second non-transitory computer-readable media (memory 88) is configured to store second computer-executable instructions configured to cause the second processor 80 to present load shedding options via the user interface 84, receive load shedding instructions from the user interface 84, and send the load shedding instructions to the EMCU 24 via the communication devices 64 and 82 of the EMCU 24 and the PED 44. Non-limiting examples of the user interface 84 provided by the PED 44 are shown below. The second computer-executable instructions may be in the form of an application program configured to generate the user interface 84, receive user input via the user interface 84, and transmit the received user input to the EMCU 24.

Referring additionally to FIG. 5, in various embodiments the circuit breaker devices 28 may include any type of controllable switch (circuit breaker switches 90) that can receive via a communication device 92 instructions or signals from the EMCU 24 for controlling on/off status. The circuit breaker switches 90 connect to one or more electrical loads 40. In various embodiments, the circuit breaker switches 90 and the communication devices 92 may be smart circuit breakers/switches, which are extremely well known in the art and no further explanation is necessary for a person of skill in the art to understand disclosed subject matter. The circuit breaker switches 90 may include controllable switches connected to multiple loads of a particular category, such as, without limitation, the heavy electrical loads (washer/dryer, dishwasher, etc.) 40 and the designated essential/critical loads 40A. The islanding contactor 57 is placed in an opened position by the EMCU 24 when the EMCU 24 detects a power outage. This ensures that power outputted by the fixed DC energy storage device(s) 30, the batteries of the mobile or removable device 32, solar panels 24, or alternative energy source are supplying power back onto the grid currently experiencing a power failure.

In various embodiments and given by way of example only and not of limitation, the communication device 64, the communication device 82, and the communication device 92 may communicate over a wire or using a high frequency pulse width modulated signals based on the standards DIN SPEC70121 and ISO/IEC 15118-series. Data communication and data communication protocols are extremely well known in the art and no further explanation is necessary for a person of skill in the art to understand disclosed subject matter.

In various embodiments the first non-transitory computer-readable media (memory 62) is configured to store first computer-executable instructions configured to cause the first processor 60 to determine a grid energy supply outage responsive to the grid energy supply value, and responsive to the determined grid energy supply outage, receive plug-in status of the removable DC energy storage device(s) 33 within the mobile or removable device 32 from the removable DC energy storage device charger 36 via the communication device 64, receive first available power information from the mobile or removable device 32 responsive to the plug-in status indicating available, receive active load power usage information received from the grid energy supply sensor 23, and send a first off instruction to a first one of the plurality of circuit breaker devices 28 responsive to the determined active load power usage information being greater than a first shedding threshold associated with the first available power information responsive to the first available power information being greater than a minimum reserve threshold.

In various embodiments the shedding threshold may be a list of the electrical loads 40 or the circuit breaker(s) 28 that is coupled to a particular set of the electrical loads 40. The shedding threshold may be predefined by a manufacturer of the EMCU 24 or may be selectable by a user interacting with an application program presented on an interface, such as, without limitation, a display coupled to the processor 60 of the EMCU 24, the user interface 84 of the PED 44, or another comparable interface device. The minimum reserve threshold may be a value selected to ensure that the amount of available power below that threshold would be enough to allow the mobile or removable device 32 to have enough power to be used for other purposes, such as, without limitation, getting to a charging facility, a health care facility, etc.

In various embodiments the first computer-executable instructions are further configured to cause the first processor 60 to, responsive to the plug-in status indicating available, the first available power information being greater than the minimum reserve threshold, and the determined active load power usage information being less than the first shedding threshold, receive a forecast of grid power reinstatement, estimate a first back-up target time responsive to the first available power information, and send a second off instruction to a second one of the circuit breaker devices 28 responsive to the forecast of grid power reinstatement being later than the first back-up target time. The first and back-up target time may be estimated by determining how much stored power is available and how long that would last with power usage equating to a current active load power usage value. The first computer-executable instructions are further configured to cause the first processor 60 to send the first off instruction further responsive to the sent load shedding instructions.

In various embodiments the first computer-executable instructions are further configured to cause the first processor 60 to send a third off instruction to a third one of the circuit breaker devices 28 responsive to the plug-in status indicating unavailable and the determined active load power usage information being greater than a second shedding threshold.

The plug-in status of “available” indicates that the removable DC energy storage device(s) 33 is connected to the removable DC energy storage device charger 36, regardless of the state of charge of the removable DC energy storage device(s) 33. Thus, the removable DC energy storage device(s) 33 is available to provide information or power. The plug-in status of “unavailable” indicates that the removable DC energy storage device(s) 33 is not connected to the removable DC energy storage device charger 36, thus the removable DC energy storage device(s) 33 is unavailable to provide information or power.

In various embodiments the first computer-executable instructions are further configured to cause the first processor 60 to, responsive to the plug-in status indicating unavailable and the determined active load power usage information being less than the second shedding threshold, receive a forecast of grid power reinstatement, estimate a second back-up target time responsive to available energy in the fixed DC energy storage device 30, and send a fourth off instruction to a fourth one of the circuit breaker devices 28 responsive to the forecast of grid power reinstatement being later than the second back-up target time.

In various embodiments the first computer-executable instructions are further configured to cause the first processor 60 to receive an update of the forecast of grid power reinstatement responsive to the forecast of grid power reinstatement being less than the second back-up target time. The EMCU 24 repeats analysis using the updated forecast of grid power reinstatement to determine if more load shedding is warranted.

In various embodiments and given by way of example only and not of limitation, the removable DC energy storage device 33 of the mobile or removable device 32 or the fixed DC energy storage device(s) 30 suitably includes high energy rechargeable batteries that store electrical charge, discharge electrical current upon request, and recharge. The battery or batteries may be structured in any desirable form, such as without limitation cylindrical, pouch, prismatic, massless, or other comparable forms. In various embodiments the battery or batteries include iron-air batteries, Li-ion batteries, such as without limitation Nickel Cobalt Aluminium, Lithium Manganese Cobalt, or Lithium Manganese Oxide batteries. However, other materials may be used that provide comparable recharging, energy density, and energy discharge capabilities.

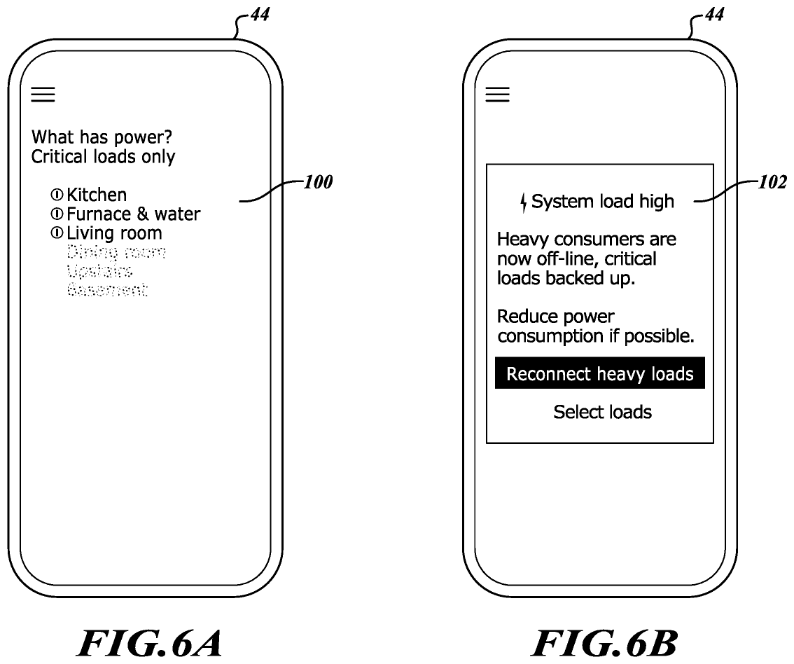

Referring additionally to FIG. 6A, in various embodiments the PED 44 presents a first image 100 on the display of the PED 44 in a first mode of operation. In the first mode of operation, the first image 100 shows a list of electrical loads that are disconnected and that critical loads are still connected. At a FIG. 6B, a second image 102 on the display of the PED 44 indicates to the user that electrical loads are current drawing a high amount of current (“System load high”). The second image 102 indicates that heavy consumers (high power drawing electrical loads) are now off-line and critical loads are backed up. At this point the user may manually deactivate certain electrical loads they believe are not needed at the time in order to reduce electrical load on the system 20. Once the user has completed manual deactivation, the user selects a reconnect heavy loads button, causing the PED 44 to provide an instruction to the EMCU 24 and thus the associated circuit breakers 28 to turn on the non-deactivated heavy loads.

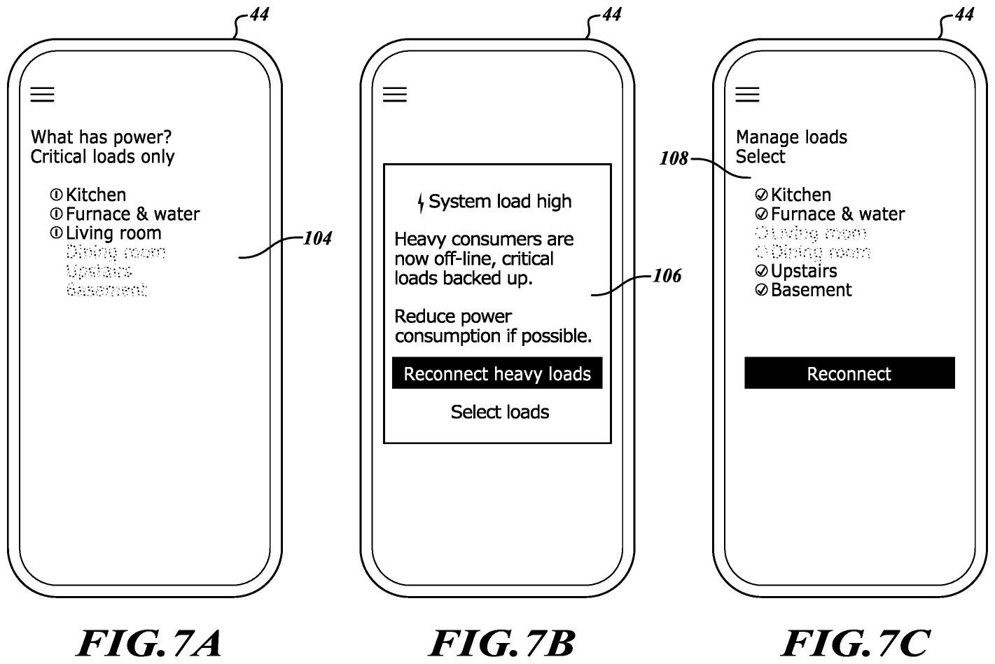

Referring additionally to FIG. 7A, in various embodiments the PED 44 presents a third image 104 that shows the same user interface as the first image 100 of FIG. 6A. As shown in FIG. 7B, the PED 44 presents a fourth image 106 that shows the same user interface as the second image 102 of FIG. 6B. However, in the fourth image 106 the user is able to select a select loads button, thus causing the PED 44 to present a fifth image 108 for allowing a user to select electrical loads the user wishes to reactivate. After interacting or not with the fifth image 108, the fourth image 106 returns, thus allowing the user to select to reconnect heavy loads by selecting the reconnect heavy loads button as described in FIG. 6B above.

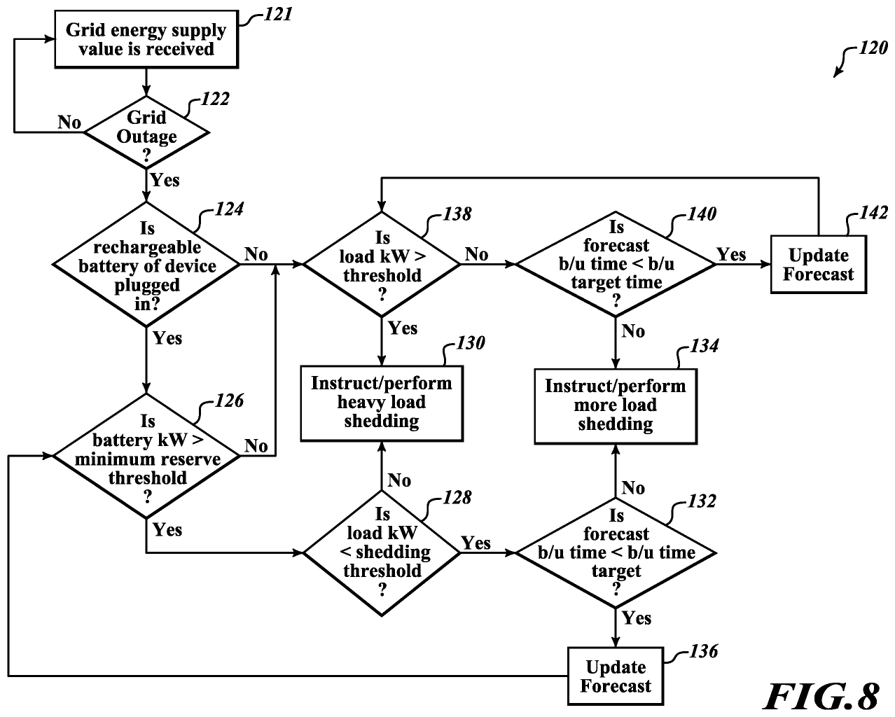

Referring additionally to FIG. 8, an illustrative process 120 may be performed for managing reserve power usage during a grid power supply outage to an electrical system of a structure. It will be appreciated that, in some embodiments the method 120 may be suited for being performed by a control unit executing instructions stored in a memory. At a block 121, a grid energy supply value is received. At a block 122, a grid energy supply outage is sensed responsive to the received grid energy supply value. At a block 124, responsive to sensing the grid energy supply outage, plug-in status of a removable DC energy storage device is determined. At a block 126, first available power information of the removable DC energy storage device is determined responsive to the plug-in status indicating available. At a block 128, active load power usage information is received, responsive the first available power information being greater than a minimum reserve threshold. At a block 130, a first electrical load is shed or deactivated responsive to the determined active load power usage information being greater than a first shedding threshold associated with the first available power information.

In some embodiments, at a block 132, responsive to the plug-in status indicating available, the first available power information being greater than the minimum reserve threshold, and the determined active load power usage information being less than the first shedding threshold, a forecast of grid power reinstatement is received and a first back-up target time is estimated responsive to the first available power information. At a block 134, a second electrical load is shed responsive to the forecast of grid power reinstatement being later than the first back-up target time.

In some embodiments, at a block 130, responsive to the plug-in status indicating unavailable, a third electrical load is shed or deactivated responsive to the determined active load power usage information being greater than a second shedding threshold at a block 138.

In some embodiments, at a block 140, responsive to the plug-in status indicating unavailable and the determined active load power usage information being less than the second shedding threshold, a forecast of grid power reinstatement is received and a second back-up target time is estimated responsive to available energy in a fixed DC energy storage device. At a block 134, a fourth electrical load is shed or deactivated responsive to the forecast of grid power reinstatement being later than the second back-up target time.

In some embodiments, at a block 142, an update of the forecast of grid power reinstatement is received responsive to the forecast of grid power reinstatement being less than the second back-up target time.

In some embodiments, load shedding instructions are received from a portable user interface device. The first electrical load is shed or deactivated further responsive to the received load shedding instructions.

In some embodiments, after the heavy load shedding performed at the blocks 130 and 134, the process 120 may reassess amount of available power from any source, such as the fixed DC energy storage device, the removable DC energy storage device, the grid, or any other energy source. The heavy loads are reconnected, responsive to either determining that the amount of available power is greater than the first or second load shedding threshold or determining that the amount of available power increases the backup target time such that it becomes greater than the forecast of grid power reinstatement (backup time). The reconnection occurs responsive to the heavy loads being automatically disconnected. Notification of heavy loads being reconnected may be sent to a user via a mobile device of the user.

Those skilled in the art will recognize that at least a portion of the EMCU 24, the removable DC energy storage device charger 36, the PED 44, controllers, processors, components, devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and application programs, one or more interactive devices (e.g., a touch pad, a touch screen, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

The term controller, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of controller (e.g., at a first time), as a second type of controller (e.g., at a second time, which may in some instances coincide with, overlap, or follow a first time), and/or as a third type of controller (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first controller that has a first purpose, then a second controller that has a second purpose and then, a third controller that has a third purpose, and so on. The transition of a reconfigurable and/or controllable component may occur in as little as a few nanoseconds, or may occur over a period of minutes, hours, or days.

In some such examples, at the time the controller is configured to carry out the second purpose, the controller may no longer be capable of carrying out that first purpose until it is reconfigured. A controller may switch between configurations as different components/modules in as little as a few nanoseconds. A controller may reconfigure on-the-fly, e.g., the reconfiguration of a controller from a first controller into a second controller may occur just as the second controller is needed. A controller may reconfigure in stages, e.g., portions of a first controller that are no longer needed may reconfigure into the second controller even before the first controller has finished its operation. Such reconfigurations may occur automatically, or may occur through prompting by an external source, whether that source is another component, an instruction, a signal, a condition, an external stimulus, or similar.

For example, a central processing unit or the like of a controller may, at various times, operate as a component/module for displaying graphics on a screen, a component/module for writing data to a storage medium, a component/module for receiving user input, and a component/module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple components/modules, the example includes the possibility that the same hardware may implement more than one of the recited components/modules, either contemporaneously or at discrete times or timings. The implementation of multiple components/modules, whether using more components/modules, fewer components/modules, or the same number of components/modules as the number of components/modules, is merely an implementation choice and does not generally affect the operation of the components/modules themselves. Accordingly, it should be understood that any recitation of multiple discrete components/modules in this disclosure includes implementations of those components/modules as any number of underlying components/modules, including, but not limited to, a single component/module that reconfigures itself over time to carry out the functions of multiple components/modules, and/or multiple components/modules that similarly reconfigure, and/or special purpose reconfigurable components/modules.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (for example “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software (e.g., a high-level computer program serving as a hardware specification), firmware, or virtually any to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software (e.g., a high-level computer program serving as a hardware specification) and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

As discussed above, various embodiments include the non-transitory computer-readable storage medium (e.g., the memory 62 and 88) having computer-readable code (instructions) stored thereon for causing the EMCU 24 or the PED 44 to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include the instructions executable by the PCC 44 that, in response to such execution, causes performance of a set of operations, steps, methods, processes, algorithms, functions, techniques, etc. as described herein for the various embodiments.

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

What is claimed is:

1. An energy management control unit comprising:
a communication device;
a processor configured to receive and send information to electrical components via the communication device; and
non-transitory computer-readable media configured to store computer-executable instructions configured to cause the processor to:
determine first available power information of a removable DC energy storage device;
receive active load power usage information responsive to the first available power information being greater than a minimum reserve threshold; and
shed a first electrical load responsive to the received active load power usage information being greater than a first shedding threshold associated with the first available power information.

2. The energy management control unit of claim 1, wherein the computer-executable instructions are further configured to cause the processor to:
receive a grid energy supply value; and
determine a grid energy supply outage responsive to the received grid energy supply value,
wherein determining the first available power information of the removable DC energy storage device is responsive to the determined grid energy supply outage.

3. The energy management control unit of claim 2, wherein the computer-executable instructions are further configured to cause the processor to, responsive to the first available power information being greater than a minimum reserve threshold and the determined active load power usage information being less than the first shedding threshold:
receive a forecast of grid power reinstatement;
estimate a first back-up target time responsive to the first available power information; and
shed a second electrical load responsive to the forecast of grid power reinstatement being later than the first back-up target time.

4. The energy management control unit of claim 1, wherein the computer-executable instructions are further configured to cause the processor to:
receive load shedding instructions from a portable user interface device;
shed the first electrical load further responsive to the received load shedding instructions.

5. The energy management control unit of claim 1, wherein the computer-executable instructions are further configured to cause the processor to:
receive plug-in status of the removable DC energy storage device; and
shed a third electrical load responsive to the determined active load power usage information being greater than a second shedding threshold, responsive to the plug-in status indicating unavailable.

6. The energy management control unit of claim 5, wherein the computer-executable instructions are further configured to cause the processor to, responsive to the plug-in status indicating unavailable and the determined active load power usage information being less than the second shedding threshold:
receive a forecast of grid power reinstatement;
estimate a second back-up target time responsive to available energy in a fixed DC energy storage device;
shed a fourth electrical load responsive to the forecast of grid power reinstatement being later than the second back-up target time.

7. A system comprising:
a plurality of circuit breaker devices coupled between a plurality of electrical loads and a grid energy supply;
a removable direct current (DC) energy storage device charger;
a fixed DC energy storage device;
a bidirectional inverter couplable to the plurality of circuit breaker devices, the removable DC energy storage device charger, and the fixed DC energy storage device; and
an energy management control unit including:
a communication device;
a first processor configured to receive and send information to the plurality of circuit breaker devices, the bidirectional inverter, and the removable DC energy storage device charger via the communication device; and
first non-transitory computer-readable media configured to store first computer-executable instructions configured to cause the first processor to:
determine first available power information of the removable DC energy storage device;
receive active load power usage information responsive to the first available power information being greater than a minimum reserve threshold; and
send a first off instruction to a first one of the plurality of circuit breaker devices responsive to the received active load power usage information being greater than a first shedding threshold associated with the first available power information.

8. The system of claim 7, further comprising:
a grid energy supply sensor configured to sense a grid energy supply value, wherein the first computer-executable instructions are further configured to cause the first processor to:
determine a grid energy supply outage responsive to the sensed grid energy supply value,
wherein determining the first available power information of the removable DC energy storage device is responsive to the determined grid energy supply outage.

9. The system of claim 8, wherein the first computer-executable instructions are further configured to cause the first processor to, responsive to the first available power information being greater than a minimum reserve threshold and the determined active load power usage information being less than the first shedding threshold:
receive a forecast of grid power reinstatement;
estimate a first back-up target time responsive to the first available power information; and
send a second off instruction to a second one of the plurality of circuit breaker devices responsive to the forecast of grid power reinstatement being later than the first back-up target time.

10. The system of claim 9, wherein the forecast of grid power reinstatement is received from a grid power information source via the communication device.

11. The system of claim 7, further comprising:
a mobile, user interface device including:
a communication device;
a user interface configured to present information and receive input;
a second processor;
second non-transitory computer-readable media configured to store second computer-executable instructions configured to cause the second processor to:
present load shedding options via the user interface;
receive load shedding instructions from the user interface; and
send the load shedding instructions to the energy management control unit via the communication devices of the energy management control unit and the mobile, user interface device,
wherein the first computer-executable instructions are further configured to cause the first processor to send the first off instruction further responsive to the sent load shedding instructions.

12. The system of claim 7, wherein the first computer-executable instructions are further configured to cause the first processor to send a third off instruction to a third one of the plurality of circuit breaker devices responsive to the plug-in status indicating unavailable and the determined active load power usage information being greater than a second shedding threshold.

13. The system of claim 12, wherein the first computer-executable instructions are further configured to cause the first processor to, responsive to the plug-in status indicating unavailable and the determined active load power usage information being less than the second shedding threshold:
receive a forecast of grid power reinstatement;
estimate a second back-up target time responsive to available energy in a fixed DC energy storage device; and
send a fourth off instruction to a fourth one of the plurality of circuit breaker devices responsive to the forecast of grid power reinstatement being later than the second back-up target time.

14. The system of claim 13, wherein the forecast of grid power reinstatement is received from a grid power information source via the communication device.

15. A method comprising:
determining first available power information of the removable DC energy storage device;
receiving active load power usage information responsive to the first available power information being greater than a minimum reserve threshold; and
shedding a first electrical load responsive to the received active load power usage information being greater than a first shedding threshold associated with the first available power information.

16. The method of claim 15, further comprising:
receiving a grid energy supply value; and
determining a grid energy supply outage responsive to the received grid energy supply value,
wherein determining the first available power information of the removable DC energy storage device is responsive to determining the grid energy supply outage,

17. The method of claim 16, further comprising:
responsive to the first available power information being greater than a minimum reserve threshold and the determined active load power usage information being less than the first shedding threshold,
receiving a forecast of grid power reinstatement;
estimating a first back-up target time responsive to the first available power information; and
shedding a second electrical load responsive to the forecast of grid power reinstatement being later than the first back-up target time.

18. The method of claim 15, further comprising:
receiving load shedding instructions from a portable user interface device,
wherein shedding the first electrical load is further responsive to the received load shedding instructions.

19. The method of claim 15, further comprising:
receiving plug-in status of the removable DC energy storage device; and
shedding a third electrical load responsive to the determined active load power usage information being greater than a second shedding threshold, responsive to the plug-in status indicating unavailable.

20. The method of claim 19, further comprising:
responsive to the plug-in status indicating unavailable and the determined active load power usage information being less than the second shedding threshold,
receiving a forecast of grid power reinstatement;
estimating a second back-up target time responsive to available energy in a fixed DC energy storage device; and
shedding a fourth electrical load responsive to the forecast of grid power reinstatement being later than the second back-up target time.
